(19) United States
(12) Patent Application Publication
(10) Pub. No.: US 2012/0299843 A1
(43) Pub. Date: Nov. 29, 2012

(54) REAL-TIME OBJECT TRANSFER AND INFORMATION SHARING METHOD

(76) Inventor: Hak-Doo KIM, Seoul (KR)

(21) Appl. No.: 13/239,635

(22) Filed: Sep. 22, 2011

(30) Foreign Application Priority Data
May 23, 2011 (KR) 10-2011-0048639

(51) Int. Cl. G06F 3/041

(52) U.S. Cl. 345/173

(57) ABSTRACT

A real-time object transfer and information sharing method includes receiving information on one or more devices through which communication is to be performed, setting movement of a touch having at least one selected from among directivity, time and distance within a predetermined range for each of the devices and storing a value corresponding to the movement of the touch as an individual transfer gesture with respect to the corresponding device, determining whether the movement of the touch corresponds to the individual transfer gesture if the movement of the touch is sensed, and selecting a device corresponding to the individual transfer gesture as a target device and transferring an object under execution to the target device corresponding to the individual transfer gesture upon determining that the movement of the touch corresponds to the individual transfer gesture.

### CROSS-REFERENCE TO RELATED APPLICATION

The present application claims the benefit under 35 U.S.C. §119(a) to a Korean patent application No. 10-2011-0048639, filed on May 23, 2011, and the disclosure of which is expressly incorporated by reference in its entireties.

### BACKGROUND OF THE INVENTION

1. Field of the Invention

The present invention relates to a real-time object transfer and information sharing method, and more particularly to a real-time object transfer and information sharing method that is capable of transferring user standardized data (image, video, document, audio, Flash, etc.) in real time through data transfer between a plurality of devices, thereby sharing the data between the respective devices and recognizing information.

2. Description of the Related Art

An offline method type of giving presentation to the audience, thinking together and receiving opinions from the audience during learning, seminars or meetings is a conventional lecturing method, which has been generally used up to now. In this method type, however, it is difficult to induce a more active participation of the audience or perform exchange of opinions with the audience or people who are not present in the same space.

For a lecture directed to students, the lecture is given using a blackboard or similar means. If the lecture is given in such a manner where questions are presented and results thereof are received and confirmed in real time, it is not possible to use the conventional offline method. Also, if a remote lecture is given, it is more difficult to perform this method type.

In order to solve the above problems, a method has been developed in which the presenter transfers necessary materials using a button or menu and the audiences receive and execute the transferred material on their devices. In this method, however, it is necessary for the audiences to open the transferred file so that they can confirm the contents of the file. In addition, if prepared documents are added or partially edited in a cooperative process, all the edited files are transferred again to perform file comparison or comparison between edited logs corresponding to a document edition history with the result which takes much time to confirm the results. Also, in this case, since all of the edited files are transferred, the capacity of the transferred data is increased, which results in the network load increase.

In addition, in this method, since the button or menu is pressed to select the desired destination to transfer data to the selected destination, intuitive transfer is not possible. Also, several procedures are executed to derive at the result which makes this method inconvenient to use. Furthermore, the required time, although short, causes real-time transfer and confirmation to be impossible.

### SUMMARY OF THE INVENTION

Therefore, the present invention has been made in view of the above problems, and it is an objective of the present invention to provide a real-time object transfer and information sharing method that is capable of transferring an object intuitively through a predetermined gesture corresponding to the movement of a touch.

Another objective of the present invention is to provide a real-time object transfer and information sharing method that is capable of transferring an object to the receiving side so that the receiving side can watch a file transferred in real time on the same screen.

Another objective of the present invention is to provide a real-time object transfer and information sharing method that is capable of editing an object and transferring only the edited portion of the object so that the edited portion of the object can be directly reflected in an object already owned by the receiving side and can be confirmed instantly by the receiving side.

Another objective of the present invention is to provide a real-time object transfer and information sharing method that is capable of reducing the capacity of a data packet through compression upon transferring an object and ensuring security and zero defects through encoding.

Another objective of the present invention is to provide a real-time object transfer and information sharing method that is capable of resizing an object to a size optimized for devices transferring and receiving the object through data scaling upon transfer of the object based on information on the devices.

In accordance with an aspect of the present invention to reach the invention's objectives, the invention is on the provision of a real-time object transfer and information sharing method, which includes receiving information on one or more devices through which communication is to be performed; setting movement of a touch having at least one selected from among directivity, time and distance within a predetermined range for each of the devices and storing a value corresponding to the movement of the touch as an individual transfers gesture with respect to the corresponding device; determining whether the movement of the touch corresponds to the individual transfer gesture if the movement of the touch is sensed, and selecting a device corresponding to the individual transfer gesture as a target device; and transferring an object under execution to the target device corresponding to the individual transfer gesture upon determining that the movement of the touch corresponds to the individual transfer gesture.

The storage step includes storing movement of a touch having directivity, time and distance within a range different from the range of the individual transfer gesture as a server transfer gesture by which an object is transferred to a server to which the devices are connected. The determination step includes determining that the movement of the touch corresponds to the individual transfer gesture or the server transfer gesture if the movement of the touch is sensed, and the transfer step includes transferring a specific touched object to the server as a shared object so that the object is registered with the server upon determining that the movement of the touch corresponds to the server transfer gesture, selecting a device connected to the server as a target device and sending a transfer command to the server so that the server transfers the registered object to the target device.

In order to reach the invention's above objectives, there includes a real-time object transfer and information sharing method which includes receiving information on a plurality of devices through which communication is to be performed; storing movement of a touch having at least one selected from among directivity, time and distance within a predetermined range as a server transfer gesture by which an object is transferred to a server to which the devices are connected; determining whether the movement of the touch with respect to a specific object corresponds to the server transfer gesture if the movement of the touch is sensed; transferring the specific object to the server as a shared object so that the object is registered in the server upon determining that the movement of the touch corresponds to the server transfer gesture; and selecting a device connected to the server as a target device and sending a transfer command to the server so that the server transfers the registered object to the target device.

The real-time object transfer and information sharing method further includes displaying the transferred object on a screen, editing the transferred object, performing movement of a touch with respect to the edited object and determining whether the movement of the touch corresponds to the transfer gesture, and transferring the edited object to the target device if the movement of the touch corresponds to the transfer gesture, wherein a edited portion of the object including position information may be transferred to the target device so that the edited portion of the object can be combined with an object previously transferred to the target device when the edited object is transferred.

The transfer step also includes transferring a edited portion of the object including position information to the target device so that the edited portion of the object can be combined with an object previously transferred to the target device when the object is edited.

The object may be any one selected from among a document, image, video, audio and flash.

The transfer step includes encoding and compressing the object.

The determination step includes determining that the movement of the touch is a movement gesture and moving the object if the sensed movement of the touch does not correspond to any one of the transfer gestures. Also, the determination step includes stopping the movement of the object and determining whether the movement of the touch corresponds to any one of the transfer gestures if the object is moving when the touch is sensed.

In addition, when transferring, it is appropriate to resize and transfer the object based on information on the target device so that the object can be displayed in the target device according to the form displayed on the transfer device.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flow chart showing the first embodiment of a real-time object transfer and information sharing method according to the present invention;

FIG. 2 is a flow chart showing the flow of a transfer command using a gesture according to the present invention;

FIG. 3 is a conceptual view showing a one-to-one transfer method according to a first embodiment of the present invention;

FIG. 4 is a flow chart showing a second embodiment of the real-time object transfer and information sharing method according to the present invention;

FIG. 5 is a conceptual view showing a connection relationship between a plurality of devices and a server;

FIG. 6 is a flow chart showing a process of registering an object with a server;

FIG. 7 is a flow chart showing an object edition process; and

FIG. 8 is a flow chart showing an object deleting process.

### DETAILED DESCRIPTION OF THE INVENTION

Now, preferred embodiments of the present invention will be described in detail with reference to the accompanying drawings.

### First Embodiment

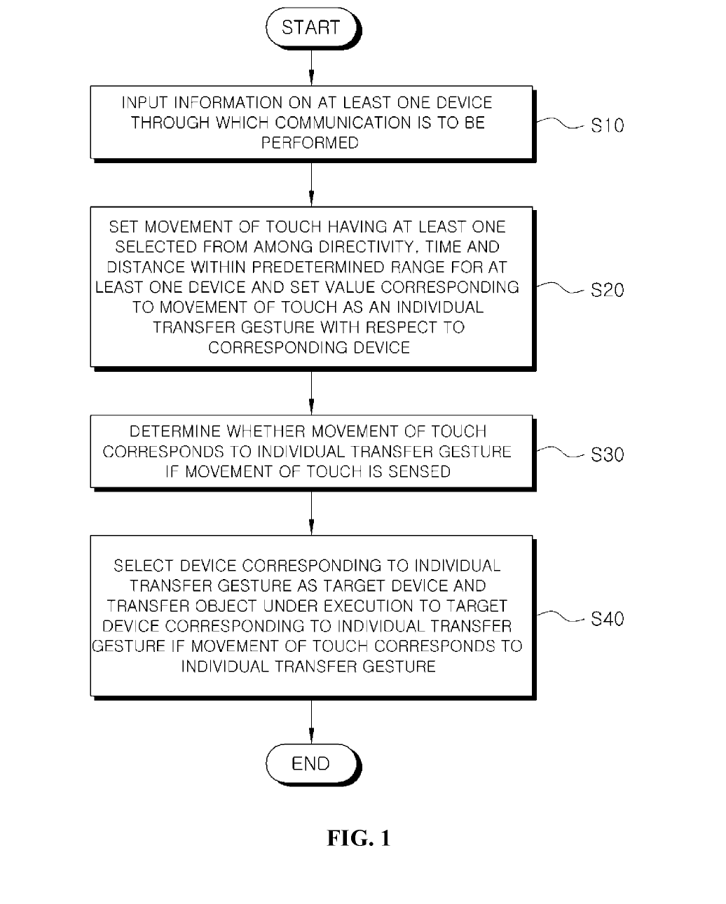

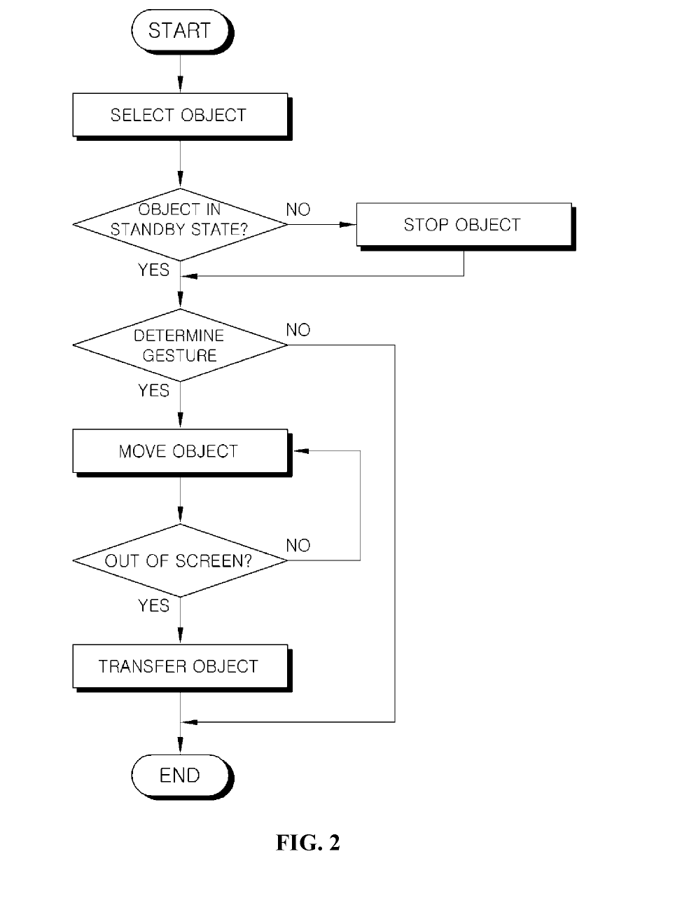

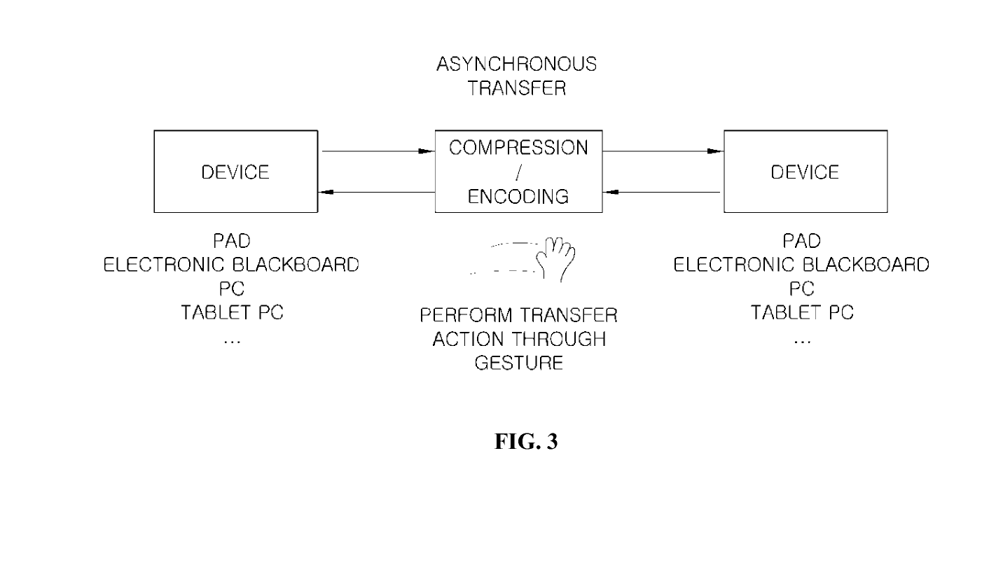

FIG. 1 is a flow chart showing a first embodiment of a real-time object transfer and information sharing method according to the present invention, FIG. 2 is a flow chart showing the flow of a transfer command using a gesture according to the present invention, and FIG. 3 is a conceptual view showing a one-to-one transfer method according to a first embodiment of the present invention.

As shown in the drawings, first, information on at least one device through which communication is to be performed is input. Here, the device may be a product, such as an electronic blackboard, a personal computer (PC), a tablet or a pad, to which an object can be transferred and the object may be data, such as video, audio, text or a Flash file. Also, a device to which the real-time object transfer and information sharing method according to the present invention is applied may be a product, such as an electronic blackboard, a PC, a tablet or a pad. Especially, the device may be a touch type product, such as a touch monitor or a touch pad.

The input information on the device may include optimized resolution, memory capacity and a data transfer and receiving method of the device (Step S10).

Also, in the present invention, an object to be transferred is transferred to a target device through the movement of a touch, i.e. a gesture, and the target device may include all or some of the aforementioned devices. Consequently, it is necessary to decide to which of the devices the object is to be transferred. To this end, in the present invention, the movement of a touch having directivity, time and distance within a predetermined range is set for at least one of the devices, and a value corresponding to the movement of the touch is stored as an individual transfer gesture with respect to the corresponding device.

For example, different devices may be matched with respect to the movement of a touch to the left side of a screen, the movement of the touch to the right side of the screen, the movement of the touch to the upper side of the screen and the movement of the touch to the lower side of the screen. Alternatively, a target device may be matched based on the distance in which the movement of the touch is moved on the screen in a straight line or in a curved line. Also, the movement of the touch may be divided using a concept of acceleration based on directivity, time and distance to match the target device.

In the present invention as described above, the determination of a gesture is not necessarily performed using all of the directivity, time and distance but may be performed using one or two factors among directivity, time and distance.

At this, one or more devices may be set that match each direction.

In this embodiment, using acceleration based on the directivity, time and distance is illustrated, and therefore, the movement of the touch will be described hereinafter based on the concept of acceleration.

A method of recognizing the movement of the touch, i.e. the gesture, may be expressed as represented by the following mathematical expression.

CalTime=(ThisTime−LastTime)/2 [Mathematical expression 1]

Where, ‘ThisTime’ indicates the present time, and ‘LastTime’ indicates the immediately recognized previous time during recognition. Consequently, ‘CalTime’ indicates the average time between the present time and the immediately recognized previous time during recognition.

Vxp=(Xp−Xpp)/(ThisTime−LastTime)

Vyp=(Yp−Ypp)/(ThisTime−LastTime) [Mathematical expression 2]

Where, ‘Xp’ and ‘Yp’ indicate an X coordinate and a Y coordinate of a position at which the present motion is performed, and ‘Xpp’ and ‘Ypp’ indicate the X coordinate and Y coordinate of the immediately recognized previous position during recognition. Consequently, ‘Vxp’ and ‘Vyp’ indicate the X-direction velocity and Y-direction velocity, i.e. instantaneous velocity, from the immediately recognized previous position during recognition to the present position.

Vxo=(Xo−Xp)/(ThisTime−LastTime)

Vyo=(Yo−Yp)/(ThisTime−LastTime) [Mathematical expression 3]

Where, ‘Xo’ and ‘Yo’ indicate the X coordinate and Y coordinate of a position at which a touch is initiated, and ‘FirstTime’ indicates time at which the initiation of the touch is recognized. Consequently, ‘Vxo’ and ‘Vyo’ indicate X-direction velocity and Y-direction velocity, i.e. average velocity, from the position at which the touch is initiated to the present position.

Ax=(Vxo−Vxp)/CalTime

Ay=(Vyo−Vyp)/CalTime [Mathematical expression 4]

Where, ‘Ax’ and ‘Ay’ indicate acceleration in the X-axis direction and in the Y-axis direction.

xx=Xo+(Vxo×tD+(½)×Ax×tD×tD)

yy=Yo+(Vyo×tD+(½)×Ay×tD×tD) [Mathematical expression 5]

Where, ‘tD’ indicates a delay (a constant value considering delay time), and ‘xx’ and ‘yy’ indicate a predicted X value and a predicted Y value. In this embodiment, 0.06 is used as tD.

The predicted X value and Y value are calculated based on Mathematical expression 1 to Mathematical expression 5. That is, when a gesture motion is initiated, the x and y coordinates to be moved are predicted based on positions Xo and Yo at which the gesture motion is initiated, positions Xp and Yp at which the present motion is performed, positions Xpp and Ypp recognized immediately before the present motion, the initiated time FirstTime, the present time ThisTime and the time recognized immediately before the present motion.

In Mathematical expression 5, xx and yy are predicted values. If the difference between the predicted values and the preset x and y positions exceeds the minimum motion value (for example, 100 pixels) to perform transfer, the predicted values are transferred. If the predicted values fall within predetermined ranges (for example, 100 to 150, 151 to 200 and 201 pixels or more for three steps), a gesture generating the predicted value is confirmed and stored as an individual transfer gesture.

In brief, the gesture recognition method according to this embodiment analyzes the present motion to predict an expected route and compares the expected route with a predicted value to determine the expected route. Acceleration Ax and Ay is obtained in order to determine the expected route. Instantaneous velocity Vxp and Vyp and average velocity Vxo and Vyo are obtained in order to obtain the acceleration. At this, the acceleration Ax and Ay is not obtained using only the instantaneous velocity so that directivity and value of the acceleration are analyzed to improve a recognition rate.

Patterns of such a gesture are previously learned so that one or more devices are set for each pattern of the gesture. At this, it is preferable to decide a pattern of an individual transfer gesture to select a specific device so that the movement of the touch corresponds to the corresponding individual transfer gesture if the movement of the touch falls within a predetermined range (Step S20).

Next, if the movement of the touch is sensed, it is determined whether the movement of the touch corresponds to the individual transfer gesture. The determination process is performed based on the calculation of the actual movement of the touch through Mathematical expression 1 to Mathematical expression 5 to determine whether the movement of the touch falls within a predetermined range (Step S30).

If the sensed movement of the touch does not correspond to any one of the transfer gestures in the determination process, it is determined that the movement of the touch is a movement gesture, and the object is moved.

Also, if the object is moving when the touch is sensed in the determination process, the movement of the object is stopped, and it is determined whether the movement of the touch corresponds to the individual transfer gesture. If the movement of the touch does not correspond to the individual transfer gesture, although the movement of the object is stopped and the movement of the touch is sensed, the movement of the object is stopped but the object is not transferred.

If the movement of the touch corresponds to the individual transfer gesture, on the other hand, a device corresponding to the individual transfer gesture is selected as a target device, and the object under execution is transferred to the target device corresponding to the individual transfer gesture. At this, the object transferred to the target device is encoded and compressed in order to reduce the capacity of a data packet and, at the same time, to ensure security and zero defects. Decoding and decompression are performed by the target device, to which the encoded and compressed object is transferred.

The method of encoding and compressing an object may be one well known to people with general skills in the technical field to which the present invention pertains. An encoding and compression method used in this embodiment is described as the following.

In the present invention, when data are transferred through a network, the data are compressed and encoded in order to reduce the data packet size and to protect data. At this, the most efficient compression and encoding method is performed according to the type of the object to be transferred.

If the object is a document, lossless compression is used in order to reduce the capacity of the packet during transfer. Basically, the object is compressed using a Lempel-Ziv algorithm. According to this algorithm, if patterns identical to the present pattern are present in the vicinity thereof, a dictionary is made to register the patterns. The patterns are replaced by numbers registered in the dictionary. The dictionary is attached immediately after the header of a file and the compressed data are attached behind the dictionary. In this way, the final compressed file is prepared and transferred.

If the object is an image, it is necessary to transfer the image data inside the memory. When transferring the image data to a target device, it is necessary to compress the data due to the high capacity of the original image data inside the memory. At this, the target device is decided and the object is transferred in a state in which information on the device is known. If too large an image is transferred to the target device, the image may not be displayed in a screen at once but may be scrolled.

In order to prevent such inconvenience, the image is resized to a size suitable for the screen of the target device and loss compressed, which are smart functions. First of all, bilinear image interpolation is used to resize the image to a size most suitable for the target image. Conversion to YCbCr color space data is performed (since human eyes are more sensitive to a color component than to a brightness component, conversion to the YCbCr color space is performed so as to compress color information much more), and color information of a two-dimensional planar space is Fourier transformed to two-dimensional frequency information.

When sixteen DCT coefficients are obtained, the DCT coefficients are arranged in a block of a 4×4 matrix. The DCT coefficients are disposed from the left side upper end to the right side lower end of the block (DC coefficients are disposed at the left side upper end of the block, and AC coefficients are disposed at the remaining region of the block). A quantization process to round the DCT coefficients to integers is performed, and the difference between the DC coefficients of this block and DC coefficients of the previous block is calculated so as to easily perform entropy coding. The aforementioned process makes the respective blocks similar to each other so that entropy coding can be easily performed. Subsequently, entropy coding is performed. In this case, final compression is performed using a Hoffman code. The resultant is compressed in the same format as the compression of the document, and the compressed resultant is transferred.

If the object is video, the object is transferred in a streaming format using an H.264 codec.

If the object is a Flash object, the object is losslessly compressed and transferred according to the same method as used in the compression of the document.

Meanwhile, during the object transfer, bits of the transferred packets are reversed by encoding. The target device reverses the data transferred in packet units to complete the data (Step S40).

The decompressed and decoded object is executed at the target device. Of course, the target device can transfer the object to another device in the same method as the above.

More specifically, the target device displays the transferred object on a screen. In this state, the transferred object may be selectively edited.

If the transferred object is edited, the movement of a touch is performed with respect to the edited object, and it is determined whether the movement of the touch corresponds to the transfer gesture. At this, a process of determining the transfer gesture is identical to the above, and therefore, it is necessary for the target device to be a touch-sensible product.

If the movement of the touch corresponds to the transfer gesture, the edited object is transferred to the target device. At this time, if the edited object is transferred, the edited portion of the object including position information is transferred to the target device so that the edited portion of the object can be combined with the object previously transferred to the target device.

When the edited portion of the object is transferred, the object is displayed on the screen in a state in which the edited portion of the object is overlapped with a corresponding portion of the previously transferred object based on the position information of the edited portion of the object.

Hereinafter, the transfer process using the aforementioned gesture will be described with reference to FIG. 2.

First, an object to be transferred is selected.

Subsequently, it is checked whether the selected object is moving. Upon checking that the selected object is moving, the movement of the object is stopped, and an algorithm to determine whether the movement of a subsequent touch corresponds to an individual transfer gesture is executed. On the other hand, upon checking that the selected object is not moving, i.e. stops, it is confirmed that the object is in a standby state, and it is determined whether the movement of the touch corresponds to an individual transfer gesture.

Determination as to whether the movement of the touch corresponds to the individual transfer gesture is performed based on the calculation of acceleration (directivity, time and distance) from a position at which the touch is initiated and time when the touch is initiated to a position at which the touch is ended and time when the touch is ended. At this time, the target device corresponding to the individual transfer gesture is confirmed.

Upon determining that the movement of the touch corresponds to the transfer gesture as the result of the determination, the movement of the object is continuously performed until the object disappears from the screen. If the object completely disappears from the screen, the transfer of the object to the target device is commenced.

Hereinafter, one-to-one transfer of an object will be described with reference to FIG. 3.

If an object is transferred to a specific destination as described above, the object is encoded and compressed in order to reduce the capacity of the data packet and, at the same time, to ensure security and zero defects. The compressed and encoded packet is decoded by the target device, to which the object is transferred.

In a one-to-one transfer of the object, transfer through a gesture is performed. Asynchronous transfer is performed between two devices performing the one-to-one transfer of the object.

Such a process will be described based on the object type.

If the object is a document, first, a document to be transferred to the target device is selected. At this time, if the document is in motion (i.e. the document is not in a standby state), the movement of the document, which is moving, is stopped. Also, the movement of the touch (i.e. the gesture) is determined to select whether the document is to be moved or transferred.

Upon determining that the gesture is a movement gesture, the selected document is moved in the present device. On the other hand, upon determining that the gesture is an individual transfer gesture, the selected document is compressed and encoded, and the compressed and encoded document is transferred to the target device.

If the object is a video, the video to be transferred to the target device is selected. At this time, if the video is in motion, the movement of the video, which is moving, is stopped. Also, the movement of the touch (i.e. the gesture) is determined to select whether the video is to be moved or transferred.

Upon determining that the gesture is a movement gesture, the selected video is moved in the present device. On the other hand, upon determining that the gesture is an individual transfer gesture, the selected video is compressed and encoded, and the compressed and encoded video is transferred to the target device.

If the object is an image, the image to be transferred to the target device is selected. At this time, if the image is in motion, the movement of the image, which is moving, is stopped. Also, the movement of the touch (i.e. the gesture) is determined to select whether the image is to be moved or transferred.

Upon determining that the gesture is a movement gesture, the selected image is moved in the present device. On the other hand, upon determining that the gesture is an individual transfer gesture, the selected image is compressed and encoded, and the compressed and encoded image is transferred to the target device.

If the object is a Flash object, a Flash object to be transferred to the target device is selected. At this time, if the Flash object is in motion, the movement of the Flash object, which is moving, is stopped. Also, the movement of the touch (i.e. the gesture) is determined to select whether the Flash object is to be moved or transferred.

Upon determining that the gesture is a movement gesture, the selected Flash object is moved in the present device. On the other hand, upon determining that the gesture is an individual transfer gesture, the selected Flash object is compressed and encoded, and the compressed and encoded Flash object is transferred to the target device.

In this embodiment, the document, the image, the video and the Flash are illustrated and described as the object. Alternatively, data having other formats may be transferred in a method similar to the above.

### Second Embodiment

Hereinafter, a second embodiment of the real-time object transfer and information sharing method according to the present invention will be described.

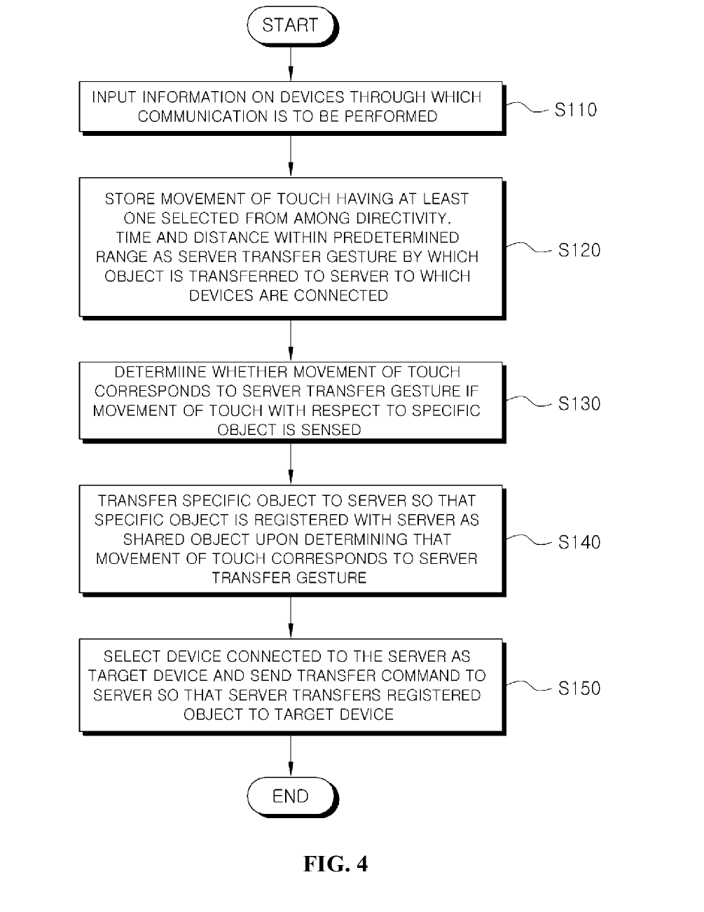

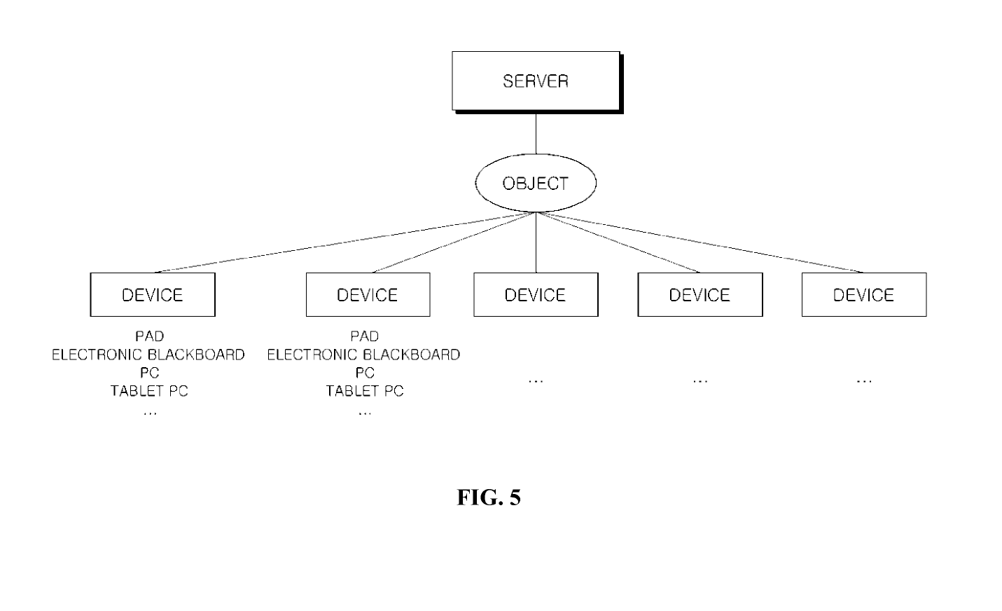

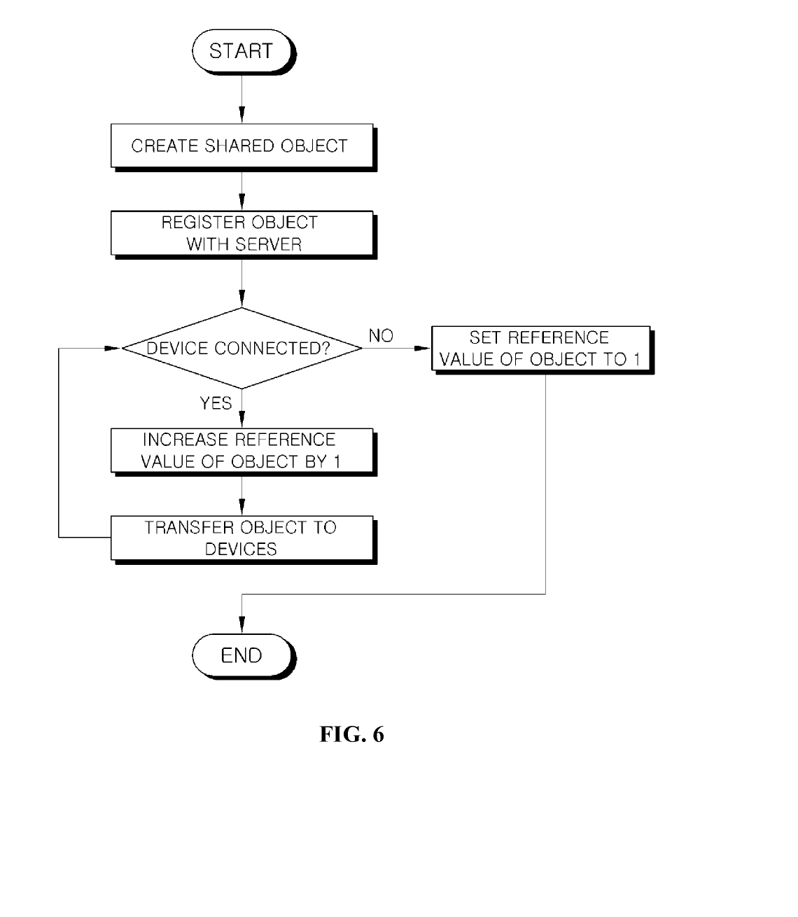

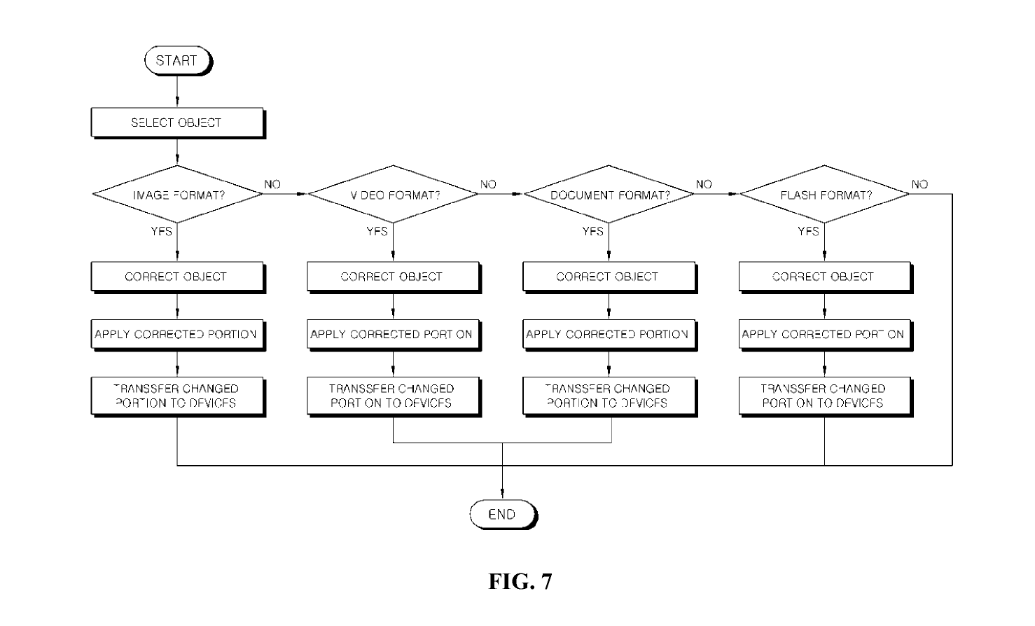

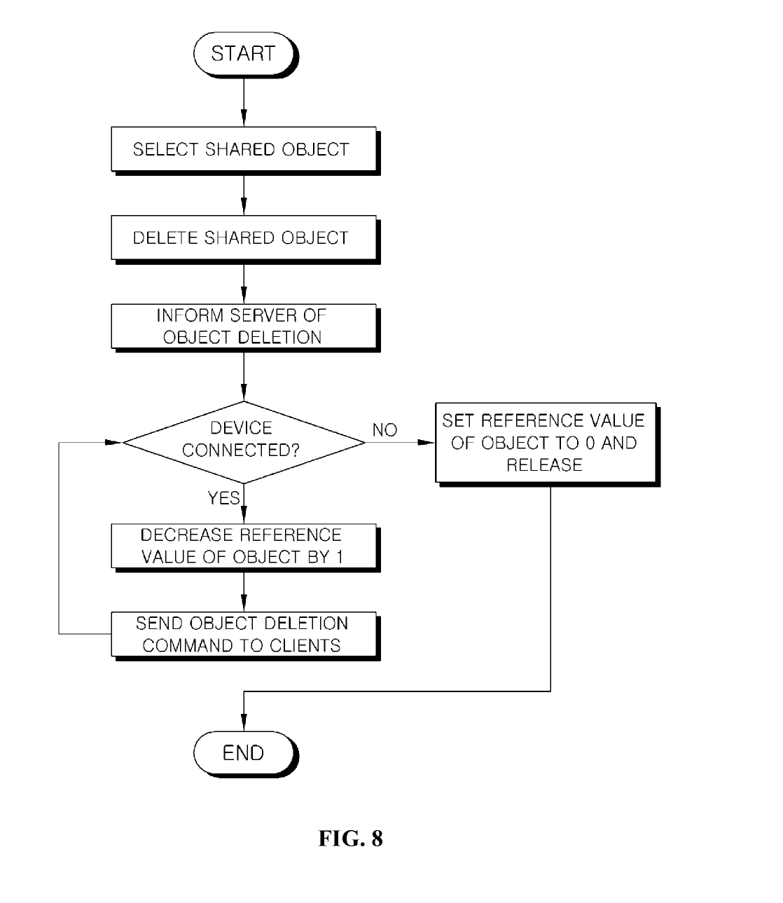

FIG. 4 is a flow chart showing flow chart showing a second embodiment of the real-time object transfer and information sharing method according to the present invention, FIG. 5 is a conceptual view showing a connection relationship between a plurality of devices and a server according to the second embodiment, FIG. 6 is a flow chart showing a process of registering an object with a server, FIG. 7 is a flow chart showing an object edition process, and FIG. 8 is a flow chart showing an object deletion process.

This embodiment relates to transfer of an object between a plurality of devices, not one-to-one transfer of the object. That is, in this embodiment, when data are shared and transferred between a plurality of devices, a shared object method is used to share the data so that the object can be managed by a device functioning as a server. This method minimizes network load and decreases response time. Also, a method to transfer the entirety of the attribute of an actual object through the network is not used but a method to transfer only the edited portion of the object is used to minimize network load.

An object registration and transfer function of this embodiment will be described in detail with reference to FIGS. 4 and 5.

First, information on a plurality of devices through which communication is to be performed is input (Step S110).

The movement of a touch having at least one selected from among directivity, time and distance within a predetermined range is stored as a server transfer gesture by which an object is transferred to a server to which the devices are connected (Step S120).

At this time, if the movement of a touch with respect to a specific object is sensed, it is determined whether the movement of the touch corresponds to the server transfer gesture (Step S130). Upon determining that the movement of the touch corresponds to the server transfer gesture, the specific object is transferred to the server so that the specific object is registered with the server as a shared object (Step S140).

On the other hand, upon determining that the sensed movement of the touch does not correspond to the server transfer gesture, it is determined that the movement of the touch corresponds to the movement gesture and the object is moved. If the object is moving when the touch is sensed, the movement of the object is stopped, and it is determined whether the movement of the touch corresponds to the server transfer gesture.

If the individual transfer gesture according to the first embodiment and the server transfer gesture according to this embodiment are sorted and stored based on the directivity, time and distance of the gesture, the movement of the touch distinguished from the individual transfer gesture must be performed in order to execute the server transfer gesture.

Upon determining that the movement of the touch corresponds to the server transfer gesture, a device connected to the server is selected as a target device, and a transfer command is sent to the server so that the server transfers a registered object to the target device. As a result, the server transfers the object to the target device. At this time, if the object is registered with the server, the server may confirm a device(s) connected to the server and may transfer the object to the device(s).

At this time, in the same manner as in the first embodiment, the object transferred to the target device may be encoded and compressed (Step S150).

When transfer is performed, the target device displays the transferred object on a screen thereof. Also, if the target device edits the transferred object and the movement of a touch is performed with respect to the edited object, it is determined whether the movement of the touch corresponds to the transfer gesture. At this time, a process of determining the transfer gesture is identical to the above, and therefore, it is necessary for the target device to be a touch-sensible product.

If the movement of the touch corresponds to another transfer gesture, the edited object is transferred to the target device. At this time, if the edited object is transferred, the edited portion of the object including position information is transferred to the target device so that the edited portion of the object can be combined with the object previously transferred to the target device.

When the edited portion of the object is transferred, the object is displayed on the screen in a state in which the edited portion of the object is overlapped with a corresponding portion of the previously transferred object based on the position information of the edited portion of the object.

Hereinafter, an object transfer method according to this embodiment will be descried with reference to FIG. 6.

First, a shared object is created in the server and is registered with the server so that the shared object can be shared. A reference number of a document is increased according to the number of devices registered with the server. If there is no registered device, the reference number is set to 1.

If there is a device(s) connected to the server, all of the devices are informed that there is a registered shared object, and the shared object is transferred to all of the registered devices.

Hereinafter, edition and transfer of the object according to this embodiment will be described with reference to FIG. 7.

In order to edit the shared object, first, the object is selected and edited. The edited object is transferred in different manners according to formats, such as jpg, bmp, avi, mpeg, mp4 and ogg, of the edited object so that the edited object can be transferred in the most efficient method based on each of the formats. For an image format, the object may be resized according to resolution optimized for a target device to reduce the size of a data packet. For a video format, the object is transferred through streaming to greatly reduce waiting time.

More specifically, for an image object, only the image (color and coordinates) of a changed portion is transferred. At this time, if changed portions are present at several places, the changed portions are disposed in series in the form of a list and transferred. For example, a transfer packet of the edited portion may include identification to distinguish the shared object, coordinates of the edited image and color information of the edited image.

For a document object, the position of the edited portion and information on a portion changed (edited or added) at the position are transferred. For example, a transfer packet of the edited portion may include identification to distinguish the shared object, row number and column number of the shared object and edited contents.

For a video object, the contents are not edited and the position (offset) information of the object's current location is transferred.

For a Flash object, RTMP protocol, which is a protocol used in Flash, is utilized to conform to a shared object format.

Hereinafter, deletion of an object according to this embodiment will be described with reference to FIG. 8.

In a process of deleting a shared object, an object to be deleted is selected, and the server is notified thereof. The reference value of the object is reduced one by one according to the number of devices connected to the server to inform the device referring to the present object that the shared object has been deleted. Subsequently, the shared object is released from the server.

As is apparent from the above description, the real-time object transfer and information sharing method according to the present invention has the following effects.

According to the present invention, it is possible to transfer an object intuitively through a predetermined gesture corresponding to the movement of a touch. Consequently, the present invention has the effect of conveniently, rapidly and accurately transferring an object.

According to the present invention, it is possible to transfer an object to the receiving side so that the receiving side can watch a file transferred in real time on the same screen. Consequently, the present invention has the effect of allowing the transferring party and the receiving party to share the same object in real time.

According to the present invention, it is possible to edit an object and to transfer only the edited portion of the object so that the edited portion of the object can be directly reflected in an object already owned by the receiving side and can thereof be immediately confirmed by the receiving side. Consequently, it is not necessary to confirm edited places and smooth exchange of opinions is possible. Also, since only the edited portion is transferred, the amount of transferred data is reduced, and therefore, it is possible to efficiently use network resources.

According to the present invention, it is possible to reduce the size of a data packet through compression upon transferring an object, thereby reducing transfer time and achieving efficient network usage. Also, it is possible to ensure security and zero defects through encoding, thereby improving reliability in transfer of information transfer.

According to the present invention, it is possible to resize an object to a size optimized for devices transferring and receiving the object through data scaling upon transferring the object based on information on the devices. Consequently, it is possible for a receiving side device to confirm and participate in the same screen as one viewed at a transferring side device in real time without editing an object received by the receiving side device through transfer of the object corresponding to the properties of the devices, such as resolution. Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A real-time object transfer and information sharing method comprising:
receiving information on one or more devices through which communication is to be performed;
setting movement of a touch having at least one selected from among directivity, time and distance within a predetermined range for each of the devices and storing a value corresponding to the movement of the touch as an individual transfer gesture with respect to a corresponding device;
determining whether the movement of the touch corresponds to the individual transfer gesture if the movement of the touch is sensed;
selecting a device corresponding to the individual transfer gesture as a target device and transferring an object under execution to the target device corresponding to the individual transfer gesture upon determining that the movement of the touch corresponds to the individual transfer gesture.

2. Real-time object transfer and information sharing method according to claim 1, wherein
storage step comprises storing movement of a touch having directivity, time and distance within a range different from the range of the individual transfer gesture as a server transfer gesture by which an object is transferred to a server to which the devices are connected;
determination step comprises determining whether the movement of the touch corresponds to the individual transfer gesture or the server transfer gesture if the movement of the touch is sensed;
transfer step comprises transferring a specific touched object to the server as a shared object so that the object is registered with the server upon determining that the movement of the touch corresponds to the server transfer gesture, selecting at least one device connected to the server as a target device and sending a transfer command to the server so that the server transfers the registered object to the target device.

3. A real-time object transfer and information sharing method comprising:
receiving information on a plurality of devices through which communication is to be performed;
storing movement of a touch having at least one selected from among directivity, time and distance within a predetermined range as a server transfer gesture by which an object is transferred to a server to which the devices are connected;
determining whether the movement of the touch with respect to a specific object corresponds to the server transfer gesture if the movement of the touch is sensed;
transferring the specific object to the server as a shared object so that the object is registered with the server upon determining that the movement of the touch corresponds to the server transfer gesture;
selecting a device connected to the server as a target device and sending a transfer command to the server so that the server transfers the registered object to the target device.

4. The real-time object transfer and information sharing method according to claim 1, further comprising:
displaying the transferred object on a screen;
editing the transferred object, performing movement of a touch with respect to the edited object and determining whether the movement of the touch corresponds to the transfer gesture;
transferring the edited object to the target device if the movement of the touch corresponds to the transfer gesture, wherein an edited portion of the object including position information is transferred to the target device so that the edited portion of the object can be combined with an object previously transferred to the target device when the edited object is transferred.

5. The real-time object transfer and information sharing method according to claim 1, wherein the transfer step comprises transferring a edited portion of the object including position information to the target device so that the edited portion of the object can be combined with an object previously transferred to the target device when the object is edited.

6. The real-time object transfer and information sharing method according to claim 1, wherein the object is any one selected from among a document, image, video and Flash object.

7. The real-time object transfer and information sharing method according to claim 1, wherein the transfer step comprises encoding and compressing the object.

8. The real-time object transfer and information sharing method according to claim 1, wherein the determination step comprises determining that the movement of the touch is a movement gesture and moving the object if the sensed movement of the touch does not correspond to any one of the transfer gestures.

9. The real-time object transfer and information sharing method according to claim 1, wherein the determination step comprises stopping the movement of the object and determining whether the movement of the touch corresponds to any one of the transfer gestures if the object is moving when the touch is sensed.

10. The real-time object transfer and information sharing method according to claim 1, wherein the transfer step comprises resizing and transferring the object based on information on the target device so that the object can be displayed in the target device according to a form displayed in the transfer device.
